(19) United States
(12) Patent Application Publication
(10) Pub. No.: US 2024/0228855 A9
(43) Pub. Date: Jul. 11, 2024

(54) THERMALLY CONDUCTIVE RESIN COMPOSITION AND THERMALLY CONDUCTIVE RESIN MATERIAL

(71) Applicant: Panasonic Intellectual Property Management Co., Ltd., Osaka (JP)

(72) Inventors: Keiichi KOMATSU, Osaka (JP); Asahi KASUE, Osaka (JP); Atsushi YAMAGUCHI, Osaka (JP)

(21) Appl. No.: 18/548,316

(22) PCT Filed: Mar. 9, 2022
(86) PCT No.: PCT/JP2022/010288

§ 371 Date: Aug. 29, 2023

(30) Foreign Application Priority Data
Mar. 9, 2021 (JP) 2021-037709

(51) Int. Cl. C09K 5/14; C08K 3/22; C08L 63/00

(52) U.S. Cl. CPC C09K 5/14; C08K 3/22; C08L 63/00; C08K 2003/2227; C08K 2201/001; C08L 2207/02

(57) ABSTRACT

A thermally conductive resin composition includes a first resin phase, a second resin phase, and a thermally conductive filler. The first resin phase and the second resin phase are phase-separated. The thermally conductive filler in the first resin phase has a density higher than a density of the thermally conductive filler in the second resin phase.

### TECHNICAL FIELD

The present disclosure relates to thermally conductive resin compositions and thermally conductive resin materials. Specifically, the present disclosure relates to a thermally conductive resin composition and a thermally conductive resin material which include a thermally conductive filler.

### BACKGROUND ART

Patent Literature 1 describes a thermally conductive silicone rubber composition. The thermally conductive silicone rubber composition includes silicone rubber in which a thermally conductive inorganic filler having surface treated by a specific silane coupling agent is dispersed. Thus, also when the thermally conductive inorganic filler is highly filled, flexibility and high temperature mechanical properties are imparted to a molded product.

In general, in order to improve thermal conductivity of a thermally conductive silicone rubber composition and a molded product of the thermally conductive silicone rubber composition, a thermally conductive inorganic filler is highly filled in silicone rubber (filling amount is increased). However, when the thermally conductive inorganic filler is highly filled, a viscosity of the thermally conductive silicone rubber composition tends to increase, application of the thermally conductive silicone rubber composition becomes difficult, and forming a molded product having a desired thickness is difficult.

### CITATION LIST

### Patent Literature

Patent Literature 1: JP H11-209618 A

### SUMMARY OF INVENTION

It is an object of the present disclosure to provide a thermally conductive resin composition and a thermally conductive resin material which have improved thermal conductivity while their viscosity is suppressed from increasing.

A thermally conductive resin composition according to an aspect of the present disclosure includes a first resin phase, a second resin phase, and a thermally conductive filler. The first resin phase and the second resin phase are phase-separated. The thermally conductive filler in the first resin phase has a density higher than a density of the thermally conductive filler in the second resin phase.

A thermally conductive resin material according to an aspect of the present disclosure is a solidified material of the thermally conductive resin composition. The thermally conductive resin material includes a solid phase of the first resin phase, a solid phase of the second resin phase, and the thermally conductive filler.

### BRIEF DESCRIPTION OF DRAWINGS

FIG. 1A is a model diagram of an example of a phase-separation structure of a first resin phase and a second resin phase;

FIG. 1B is a model diagram of an example of a dispersion structure of a thermally conductive filler with respect to the first resin phase and the second resin phase;

FIG. 2A is a model diagram of another example of the phase-separation structure of the first resin phase and the second resin phase;

FIG. 2B is a model diagram of another example of the dispersion structure of the thermally conductive filler with respect to the first resin phase and the second resin phase;

FIG. 3A is a model diagram of another example of the phase-separation structure of the first resin phase and the second resin phase; and

FIG. 3B is a model diagram of another example of the dispersion structure of the thermally conductive filler with respect to the first resin phase and the second resin phase.

### DESCRIPTION OF EMBODIMENTS

1. Overview

The thermally conductive resin composition according to the present embodiment includes a first resin phase, a second resin phase, and a thermally conductive filler. The first resin phase and the second resin phase are phase-separated and configure a multiphase system. The thermally conductive filler in the first resin phase has a density higher than a density of the thermally conductive filler in the second resin phase. That is, the number of particles of the thermally conductive filler included in the first resin phase per unit volume is larger than the number of particles of the thermally conductive filler included in the second resin phase per unit volume. Thus, in the case of a constant content of the thermally conductive filler with respect to the total amount of the first resin phase and the second resin phase, the particles of the thermally conductive filler come into contact with each other more easily when the thermally conductive filler is present unevenly, in a larger amount, in the first resin phase than in the second resin phase (in the thermally conductive resin composition of the present embodiment) than when the thermally conductive filler is evenly dispersed in both the first resin phase and the second resin phase. Thus, the thermally conductive resin composition of the present embodiment can have improved thermal conductivity even with a small filling amount of the thermally conductive filler. Moreover, the thermally conductive resin composition of the present embodiment has a small filling amount of the thermally conductive filler, and therefore, the viscosity of the thermally conductive resin composition is also suppressed from increasing.

The thermally conductive resin material according to the present embodiment is a solidified material of the thermally conductive resin composition according to the present embodiment and includes a solid phase of the first resin phase, a solid phase of the second resin phase, and the thermally conductive filler. Also in the thermally conductive resin material of the present embodiment, the thermally conductive filler is present unevenly, in a larger amount, in the first resin phase than in the second resin phase as in the case of the thermally conductive resin composition, and therefore, the particles of the thermally conductive filler come into contact with each other more easily than in the case where the thermally conductive filler is evenly dispersed in both the first resin phase and the second resin phase. Thus, the thermally conductive resin material of the present embodiment can have improved thermal conductivity even with a small filling amount of the thermally conductive filler.

2. Details

2-1. Thermally Conductive Resin Composition

The thermally conductive resin composition according to the present embodiment includes the first resin phase, the second resin phase, and a thermally conductive filler 3.

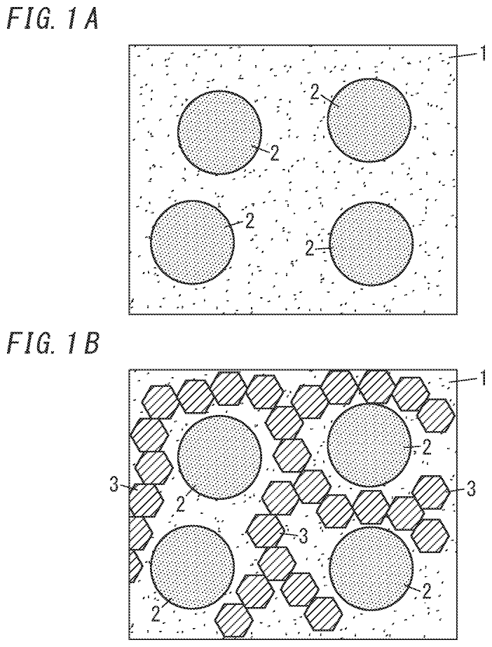

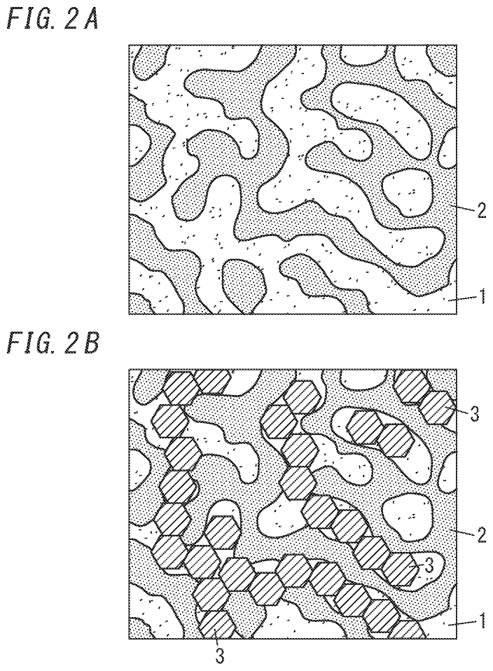

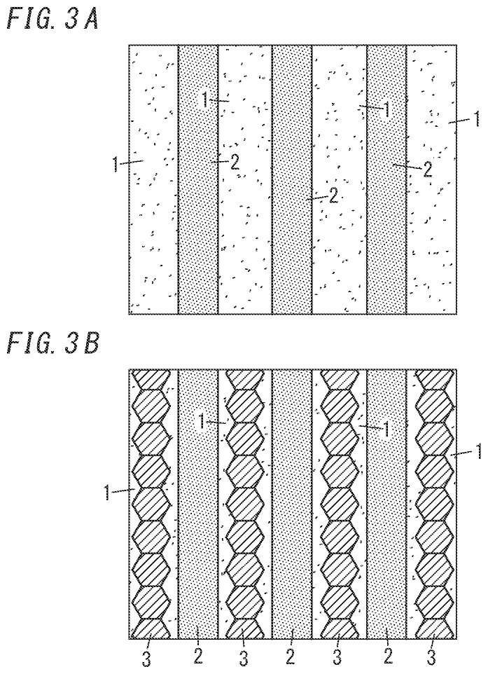

As shown in FIGS. 1A, 2A, and 3A, a first resin phase 1 and a second resin phase 2 have a phase-separation structure. That is, the first resin phase 1 and the second resin phase 2 have low compatibility and are in a separated state. FIG. 1A shows a sea-island structure of a first resin phase 1 and second resin phases 2. That is, a structure in which the second resin phases 2 are scattered in the first resin phase 1 is shown. FIG. 2A shows an interconnection structure of a first resin phase 1 and a second resin phase 2. That is, a structure in which the first resin phase 1 and the second resin phase 2 are connected to each other in a mutually invasive state is shown. FIG. 3A shows a layer structure of first resin phases 1 and second resin phases 2. That is, a structure in which the first resin phases 1 and the second resin phases 2 each having a layer shape are alternately arranged is shown.

The first resin phase 1 is made of a first resin. The first resin has flowability and is a resin in liquid form or paste form. Moreover, the second resin phase 2 is made of a second resin. The second resin has flowability and is a resin in liquid form or paste form. The first resin and the second resin are different types of resins. That is, the first resin has a solubility parameter (SP value) different from a solubility parameter of the second resin. In the present embodiment, a difference between the solubility parameter of the first resin and the solubility parameter of the second resin is preferably greater than or equal to 1. In this case, the compatibility between the first resin and the second resin is lower than in the case where the difference between the solubility parameter of the first resin and the solubility parameter of the second resin is less than 1, and thus, the first resin phase 1 and the second resin phase 2 easily form the phase-separation structure. The larger the difference is between the solubility parameter of the first resin and the solubility parameter of the second resin, the more preferable, and therefore, no particular upper limit on the difference is set.

As long as the first resin and the second resin form the phase-separation structure, any type of resin may be used. For example, a thermosetting resin is used as the first resin. The thermosetting resin is uncured, and, for example, an uncured epoxy resin in liquid form is used. Examples of such an epoxy resin include a bisphenol A epoxy resin. Moreover, as the second resin, for example, a thermoplastic resin is used. The thermoplastic resin is, for example, melted and is in liquid form, and is, for example, polyether sulfone, a silicone resin, an acrylic resin, or a urethane resin. Among these resins, the polyether sulfone, which easily forms, with the bisphenol A epoxy resin, the phase-separation structure is preferably used. Note that the first resin and the second resin may each include an appropriate solvent for the purpose of, for example, viscosity adjustment. Moreover, the ratio of the first resin to the second resin is not particularly limited as long as the phase-separation structure of the first resin phase 1 and the second resin phase 2 can be formed, but the ratio is, for example, within a range of from 95:5 to 30:70 by weight, more preferably from 90:10 to 50:50 by weight. When the first resin is grossly excessive and the second resin is too little, a state close to a single layer state of the first resin phase 1 results, and a preferred phase-separation structure is no longer obtainable. Further, when the first resin decreases, the presence ratio of the first resin phase 1 also decreases, and when the first resin phase 1 decreases in size more than necessary, the effect of improving the thermal conductivity by the phase-separation structure may no longer be satisfactorily obtained. Furthermore, when the first resin decreases, the thermally conductive filler unevenly present in the first resin phase 1 tends to enter a saturated state, and consequently, a surplus thermally conductive filler enters the second resin phase 2, and therefore, the effect of improving the thermal conductivity by the phase-separation structure may plateau.

The thermally conductive filler 3 is an aggregate of particles capable of conducting heat. The thermally conductive filler 3 has higher thermal conductivity than each of the first resin phase 1 and the second resin phase 2. That is, the thermally conductive filler 3 has higher thermal resistance than each of the first resin phase 1 and the second resin phase 2. The particles included in the thermally conductive filler 3 are preferably particles including an inorganic material such as alumina or spinel. In this case, the thermally conductive filler 3 has higher thermal conductivity than in the case where particles including an organic material are used.

The thermally conductive filler 3 preferably includes a polyhedral particle. The polyhedral particle is a particle whose cross-section shape is polygonal such as hexagonal or octagonal, and the polyhedral particle has an outer surface which preferably includes a plurality of flat surfaces. The shape of the polyhedral particle can be observed by using a scanning electron microscope (SEM). When, for example, greater than or equal to 5 and less than or equal to 150 surfaces are identified on a particle observed by using an electron microscope, the particle can be determined to be a polyhedral particle. The polyhedral particle has an increased contact area with an adjacent particle as compared with a spherical particle. This improves the thermal conductivity between particles. Thus, the thermal resistance of the thermally conductive resin composition and the thermally conductive resin material is more likely to be reduced.

A distribution curve of the number of polyhedral particles—the number of surfaces of the polyhedral particle preferably has a maximum peak at a location where the surface number of the polyhedral particle is greater than or equal to 8 and less than or equal to 40. In this case, the thermal resistance of the thermally conductive resin material can be particularly effectively reduced. The reason for this may be that when the number of surfaces of the particle is greater than or equal to 14 and less than or equal to 25, easiness of contact and the size of the contact area between the particles are increased in a balanced manner, and thus, thermal conduction between the particles particularly easily occurs. The maximum peak is more preferably located within a range in which the number of surfaces of the particle is greater than or equal to 14 and less than or equal to 25, and much more preferably located within a range in which the number of surfaces of the particle is greater than or equal to 14 and less than or equal to 18. Moreover, the closer the maximum peak is to a location where the number of surfaces of the particle is close to 16, the more preferable.

The thermally conductive filler 3 is preferably an alumina filler having a gelatinization ratio of higher than or equal to 80%. In this case, the thermal resistance of the thermally conductive resin material can be effectively reduced. A reason for this may be that since the polyhedral particles easily come into surface contact with each other in the thermally conductive resin material, the transmission efficiency of heat between the particles is more likely to be increased. Another reason for this may be that since the gelatinization ratio of the alumina filler is higher than or equal to 80%, the thermally conductive filler 3 is more likely to have high thermal conductivity, and thus, the transmission efficiency of heat through the polyhedral particles is more likely to be further increased. The gelatinization ratio is more preferably higher than or equal to 110%, and much more preferably higher than or equal to 120%.

Note that the gelatinization ratio of the alumina filler is calculated from a peak height (I25.6) of an alumina a phase and a peak height (I46) of each of a γ phase, a η phase, a χ phase, a κ phase, a θ phase, and a δ phase by formula I25.6/(I25.6+I46)×100(%). The peak height (I25.6) and the peak height (I46) are obtained from a diffraction spectrum of the alumina filler obtained by using a powder X-ray diffraction device. The peak height (I25.6) appears at a location where 2θ=25.6°. The peak height (I46) appears at a location where 2θ=46°.

The thermal conductivity of the thermally conductive filler 3 is preferably greater than or equal to 30 W/m·K. In this case, the thermal resistance of the thermally conductive resin material can be particularly effectively reduced. Such high thermal conductivity of the thermally conductive filler 3 can be achieved by a high gelatinization ratio of the alumina filler.

The average particle diameter of the thermally conductive filler 3 is preferably, for example, greater than or equal to 1 μm and less than or equal to 100 μm. Note that the average particle diameter of the thermally conductive filler 3 is a median diameter (D50) calculated from a particle size distribution obtained by dynamic light scattering.

In the thermally conductive resin composition of the present embodiment, the thermally conductive filler 3 is present unevenly, in a larger amount, in the first resin phase 1 than in the second resin phase 2. That is, more particles of the thermally conductive filler 3 are present in the first resin phase 1 than in the second resin phase 2. For example, as shown in FIGS. 1B, 2B, and 3B, there are aspects in which all of the thermally conductive filler 3 included in the thermally conductive resin composition is present in the first resin phase 1 and no thermally conductive filler 3 is present in the second resin phase 2. As explained above, the thermally conductive filler 3 is present unevenly, in a larger amount, in the first resin phase 1 than in the second resin phase 2, and therefore, the density (filling density) of the particles of the thermally conductive filler 3 in the first resin phase 1 is higher than in the case where the thermally conductive filler 3 is dispersed in both the first resin phase 1 and the second resin phase 2. Thus, adjacent particles of the thermally conductive filler 3 easily come into contact with each other, which increases the contact area or increases the contact pressure of the adjacent particles of the thermally conductive filler 3. Thus, the thermal conductivity by the thermally conductive filler 3 is improved.

Preferably, more than a half of the thermally conductive filler 3 included in the thermally conductive resin composition is unevenly present in the first resin phase 1, and more preferably, more than or equal to 60% of the thermally conductive filler 3 is unevenly present in the first resin phase 1. Alternatively, all (100%) of the thermally conductive filler 3 included in the thermally conductive resin composition may be unevenly present in the first resin phase 1.

When the thermally conductive filler 3 is more dispersible in the first resin phase 1 than in the second resin phase 2, the thermally conductive filler 3 is likely to be present unevenly, in a larger amount, in the first resin phase 1 than in the second resin phase 2. That is, depending on the property of the surfaces of the particles of the thermally conductive filler 3, the thermally conductive filler 3 is likely to be present unevenly, in a larger amount, in the first resin phase 1 than in the second resin phase 2. For example, when surfaces of the particles of the thermally conductive filler 3 are provided with components (e.g., functional groups) having a stronger affinity to the first resin phase 1 than to the second resin phase 2, the thermally conductive filler 3 is more easily distributed and is likely to be present unevenly in a larger amount, in the first resin phase 1 than in the second resin phase 2. Thus, the thermally conductive filler 3 may be treated by a coupling agent. When the thermally conductive filler 3 is treated by a coupling agent, the thermally conductive filler 3 is easily successfully dispersed in the first resin phase 1 in the thermally conductive resin composition and in the thermally conductive resin material, and therefore, the thermal resistance of the thermally conductive resin material is more likely to be reduced.

The percentage by volume of the thermally conductive filler 3 with respect to the entirety of the thermally conductive resin composition is preferably higher than or equal to 60%. When the percentage by volume is higher than or equal to 60%, the thermal resistance of the thermally conductive resin material is more likely to be particularly reduced. The percentage by volume of the thermally conductive filler is more preferably higher than or equal to 70%. In this case, the thermal resistance of the thermally conductive resin material is more likely to be further reduced. It is also preferable that the percentage by volume of the thermally conductive filler 3 is lower than or equal to 80%. In this case, the thermally conductive resin composition is more likely to have good flowability, and the thermally conductive resin material is more likely to have good flexibility.

The thermally conductive resin composition is preferably in liquid form or paste form at 25° C. The viscosity of the thermally conductive resin composition at 25° C. is preferably less than or equal to 3000 Pa·s. In this case, the thermally conductive resin composition can have good moldability and is easily molded by using, for example, a dispenser into a membrane shape, a film shape, a sheet shape, a plate shape, or the like. Moreover, the thermally conductive resin composition is easily defoamed, which can suppress voids from being formed in the thermally conductive resin material. Note that viscosity is a value measured by using an E-type rotary viscometer at 0.3 rpm.

The thermally conductive resin composition is prepared by, for example, kneading the first resin, the second resin, and the thermally conductive filler 3 together. In this case, the ratio of the first resin to the second resin (volume ratio) is preferably a first resin:second resin ratio of from 1:9 to 9:1. In such a ratio, a thermally conductive resin composition and a thermally conductive resin material which have desired properties as explained above are easily obtained. For example, the first resin phase 1 is preferably formed without interruption, and thus, the plurality of particles of the thermally conductive filler 3 are also continuously in contact with each other and are unevenly present in the first resin phase 1. However, if the amount of the first resin phase 1 is too large, the thermally conductive filler 3 is excessively spread in the first resin phase 1, and thus, the plurality of particles of the thermally conductive filler 3 may difficultly come into contact with each other. In consideration of these points, the ratio of the first resin included in the first resin phase 1 to the second resin included in the second resin phase 2 is set. A more preferable ratio (volume ratio) of the first resin to the second resin is a first resin:second resin ratio of from 8:2 to 3:7. Note that the first resin phase 1 does not necessarily have to be formed without interruption, but the first resin phase 1 may be interrupted like an island of the sea-island structure, and in this case, the thermally conductive filler 3 is unevenly present in portions corresponding to the first resin phase 1, thereby improving the thermal conductivity of the thermally conductive resin composition and the thermally conductive resin material.

2-2. Thermally Conductive Resin Material

The thermally conductive resin material according to the present embodiment is a solidified material of the thermally conductive resin composition according to the present embodiment. That is, the thermally conductive resin material of the present embodiment includes a solid phase of the first resin phase 1, a solid phase of the second resin phase 2, and the thermally conductive filler 3. The first resin phase 1 which is the solid phase is a solidified material of the first resin phase 1, which is the fluid phase in the thermally conductive resin composition. The second resin phase 2 which is the solid phase is a solidified material of the second resin phase 2, which is the fluid phase in the thermally conductive resin composition. When the first resin phase 1 which is the fluid phase is an uncured thermosetting resin, the first resin phase 1 which is the solid phase includes the thermosetting resin which has been thermally cured. The thermosetting resin may be cured by a hardener. When the second resin phase 2 which is the fluid phase is a thermoplastic resin, the second resin phase 2 which is the solid phase includes a thermoplastic resin which has been cured by a temperature drop. The thermally conductive filler 3 is present unevenly, in a larger amount, in the first resin phase 1 which is the solid phase than in the second resin phase 2 which is the solid phase. The thermally conductive filler 3 is further pushed to the first resin phase 1 by stress produced when the first resin phase 1 and the second resin phase 2 are solidified. Thus, uneven distribution of the thermally conductive filler 3 into the first resin phase 1 progresses more in the case of the thermally conductive resin material than in the case of the thermally conductive resin composition.

When the thermally conductive resin material is produced from the thermally conductive resin composition, for example, the thermally conductive resin composition is molded by an appropriate method such as press molding, extrusion molding, or calendering into a membrane shape, a film shape, a sheet shape, or a plate shape. It is also preferable to mold the thermally conductive resin composition by using a dispenser into, for example, a membrane shape. Thereafter, the thermally conductive resin composition having, for example, a membrane shape is cured by heating under a condition according thereto, thereby providing a thermally conductive resin material having, for example, a membrane shape.

The thermally conductive resin material includes the thermally conductive filler 3 and is thus more likely to have low thermal resistance. The reason for this may be that as explained above, the particles of the thermally conductive filler 3 come into contact with each other in the thermally conductive resin material to form a pathway through which heat can be transmitted, and at this time, surface contact of the particles is easily achieved, thereby easily increasing the transmission efficiency of the heat between the particles.

When press pressure is being applied to the thermally conductive resin material, the thermal resistance of thermally conductive resin material in the direction of the press pressure is likely to be particularly low. The reason for this may be that the particles of the thermally conductive filler 3 easily come into contact with each other in the direction of the press-pressure. In the present embodiment, the particles easily come into surface contact with each other as described above, and therefore, the thermal resistance is particularly easily reduced by application of the press pressure, and the thermal resistance can thus be reduced even with low press pressure.

In the thermally conductive resin material according to the present embodiment, the thermal resistance can be reduced as explained above, and therefore, the thermal resistance of the thermally conductive resin material in the direction of the press pressure in a state where the press pressure is directly applied to the thermally conductive resin material under a condition with a press pressure of 1 MPa is preferably less than or equal to 0.8 K/W. In this case, the thermally conductive resin material can produce excellent thermal conductivity and easily transmits heat with a high efficiency even with low press pressure. The thermal resistance is more preferably less than or equal to 0.7 K/W, and much more preferably less than or equal to 0.6 K/W.

Note that in FIGS. 1B and 2B, the particles of the thermally conductive filler 3 are arranged such that the plurality of particles are connected one to another in the first resin phase 1 between the second resin phases 2. In FIG. 3B, the particles of the thermally conductive filler 3 are arranged such that the plurality of particles are connected one to another in the first resin phase 1 between the second resin phases 2 in an up/down direction (e.g., in a thickness direction defined with respect to the thermally conductive resin material having a sheet shape).

The thermally conductive resin composition according to the present embodiment may be used as a heat dissipation paste. Moreover, the thermally conductive resin material according to the present embodiment may be used as a heat dissipation sheet. The heat dissipation paste and the heat dissipation sheet are, for example, disposed between a chip component and a heat sink so that heat generated from the chip component is easily transmitted to the heat sink.

3. Variations

The thermally conductive resin composition including the two types of resin phases, that is, the first resin phase and the second resin phase has been described above, but this should not be construed as limiting. Alternatively, the thermally conductive resin composition may include three or more types of resin phases. In this case, the thermally conductive resin material includes three or more resin phases. For example, a resin phase including a different type of thermosetting resin form the first resin phase may also be used, or a resin phase including a different type of thermoplastic resin from the second resin phase may also be used.

The example in which one type of thermally conductive filler 3 is used has been described above, but this should not be construed as limiting. Alternatively, the thermally conductive resin composition and the thermally conductive resin material may include two or more types of thermally conductive fillers 3. For example, a plurality of types of thermally conductive fillers 3 having different particle sizes may be included in the thermally conductive resin composition and the thermally conductive resin material, or a plurality of types of thermally conductive fillers 3 having different components may be included in the thermally conductive resin composition and the thermally conductive resin material, or a plurality of types of thermally conductive fillers 3 whose cross-section shapes of the particles are different may be included in the thermally conductive resin composition and the thermally conductive resin material. Specifically, at least one selected from the group consisting of metal oxide particles, metal nitride particles, metal carbide particles, metal boride particles, and single metal particles may be used as the thermally conductive filler 3.

### EXAMPLES

A thermally conductive resin composition was prepared by employing components indicated below.
First resin: an epoxy resin (a bisphenol A epoxy resin, manufactured by JER CO., LTD., in combination with Epikote 828 and Epikote 834, SP value 13.5)
Second resin: polyether sulfone (manufactured by ICI Inc., Victrex 5003P, SP value 12.5)
Hardener (4,4′-methylene dianiline, manufactured by Tokyo Chemical Industry Co., Ltd.)
Thermally conductive filler: a polyhedron filler containing 80 mass % polyhedral spinel particles having an average particle diameter of 70 μm and doped with molybdenum, 10 mass % polyhedral spinel particles having an average particle diameter of 10 μm and doped with molybdenum, and 5 mass % polyhedral alumina particles (manufactured by Sumitomo Chemical Industry Company Limited) having an average particle diameter of 0.4 μm. The remnant (5 mass %) includes the first resin and the second resin.

The components described above were kneaded in the amounts of incorporation shown in Table 1, thereby obtaining a thermally conductive resin composition. Note that the content of the thermally conductive filler is a ratio of the thermally conductive filler to the total amount of the thermally conductive resin composition (the total amount of the first resin, the second resin, the hardener, and the thermally conductive filler).

Then, the viscosity of the thermally conductive resin composition was measured by using an E-type viscometer (model number RC-215) manufactured by TOKI SANGYO CO., LTD as a measurement device at 0.3 rpm.

Moreover, the thermally conductive resin composition was thermally pressed for two hours under conditions with a heating temperature of 150° C. and a press pressure of 1 MPa, thereby producing a sample having a thickness of 100 μm and having a sheet shape. The sample was sandwiched between two plates made of copper, and these plates applied the direct pressure to the sample under a condition with a press pressure of 1 MPa. In this state, the thermal resistance of the sample in the direction of the press pressure was measured under a room temperature by using DynTIM Tester manufactured by Mentor Graphics Corporation.

TABLE 1

| | Example | | |
|---|---|---|---|
| | 1 | 2 | 3 |
| Resin Separation State | Phase Separation | ← | ← |
| First Resin (% by volume) | 24 | ← | ← |
| Second Resin (% by volume) | 6 | ← | ← |
| Hardener (phr) | 1 | ← | ← |
| Content of Filler (% by volume) | 70 | 75 | 80 |
| Viscosity (Pa · s) | 1500 | 2000 | 2500 |
| Thermal Resistance (K/W) | 0.7 | 0.6 | 0.45 |

| | Comparative Example | | |
|---|---|---|---|
| | 1 | 2 | 3 |
| Resin Separation State | No Phase Separation | ← | ← |
| First Resin (% by volume) | 30 | ← | ← |
| Second Resin (% by volume) | 0 | ← | ← |
| Hardener (phr) | 1 | ← | ← |
| Content of Filler (% by volume) | 70 | 75 | 80 |
| Viscosity (Pa · s) | 1000 | 2100 | 2900 |
| Thermal Resistance (K/W) | 0.8 | 0.7 | 0.5 |

When Example 1 and Comparative Example 1 are compared with each other, the contents of the filler are the same, but the thermal resistance value is smaller in Example 1. When Example 2 and Comparative Example 2 are compared with each other, the contents of the filler are the same, but the thermal resistance value is smaller in Example 2, and the viscosity is also smaller in Example 2. When Example 3 and Comparative Example 3 are compared with each other, the contents of the filler are the same, but the thermal resistance value is smaller in Example 3, and the viscosity is also smaller in Example 3. Industrial Applicability

The thermally conductive resin composition of the present embodiment is applicable as a heat dissipation paste. Moreover, the thermally conductive resin material of the present embodiment is applicable as a heat dissipation sheet. The heat dissipation paste and the heat dissipation sheet are arranged, for example, between a heat radiator (heat sink) and an electronic electric component such as a transistor and a central processing unit (CPU) of a computer. The heat dissipation paste and the heat dissipation sheet conduct heat generated from the electron electric component to the heat radiator.

### REFERENCE SIGNS LIST

1 First Resin Phase
2 Second Resin Phase
3 Thermally Conductive Filler

1. A thermally conductive resin composition comprising:
a first resin phase;
a second resin phase; and
a thermally conductive filler,
the first resin phase and the second resin phase being phase-separated,
the thermally conductive filler in the first resin phase having a density higher than a density of the thermally conductive filler in the second resin phase.

2. The thermally conductive resin composition of claim 1, wherein
a difference between a solubility parameter of a first resin included in the first resin phase and a solubility parameter of a second resin included in the second resin phase is greater than or equal to 1.

3. The thermally conductive resin composition of claim 1, wherein
the thermally conductive filler includes a polyhedral particle.

4. The thermally conductive resin composition of claim 1, wherein
the thermally conductive filler includes a polyhedral particle, and
a difference between a solubility parameter of a first resin included in the first resin phase and a solubility parameter of a second resin included in the second resin phase is greater than or equal to 1.

5. The thermally conductive resin composition of claim 1, wherein
the first resin phase includes a thermosetting resin, and
the second resin phase includes a thermoplastic resin.

6. The thermally conductive resin composition of claim 5, wherein
the first resin phase includes an epoxy resin, and
the second resin phase includes polyether sulfone.

7. A thermally conductive resin material being a solidified material of the thermally conductive resin composition of claim 1, the thermally conductive resin material comprising:
a solid phase of the first resin phase;
a solid phase of the second resin phase; and
the thermally conductive filler.

8. The thermally conductive resin composition of claim 2, wherein
the first resin phase includes a thermosetting resin, and
the second resin phase includes a thermoplastic resin.

9. The thermally conductive resin composition of claim 8, wherein
the first resin phase includes an epoxy resin, and
the second resin phase includes polyether sulfone.

10. A thermally conductive resin material being a solidified material of the thermally conductive resin composition of claim 2, the thermally conductive resin material comprising:
a solid phase of the first resin phase;
a solid phase of the second resin phase; and
the thermally conductive filler.

11. The thermally conductive resin composition of claim 3, wherein
the first resin phase includes a thermosetting resin, and
the second resin phase includes a thermoplastic resin.

12. The thermally conductive resin composition of claim 11, wherein
the first resin phase includes an epoxy resin, and
the second resin phase includes polyether sulfone.

13. A thermally conductive resin material being a solidified material of the thermally conductive resin composition of claim 3, the thermally conductive resin material comprising:
a solid phase of the first resin phase;
a solid phase of the second resin phase; and
the thermally conductive filler.

14. The thermally conductive resin composition of claim 4, wherein
the first resin phase includes a thermosetting resin, and
the second resin phase includes a thermoplastic resin.

15. The thermally conductive resin composition of claim 14, wherein
the first resin phase includes an epoxy resin, and
the second resin phase includes polyether sulfone.

16. A thermally conductive resin material being a solidified material of the thermally conductive resin composition of claim 4, the thermally conductive resin material comprising:
a solid phase of the first resin phase;
a solid phase of the second resin phase; and
the thermally conductive filler.
